(19) United States
(12) Patent Application Publication
(10) Pub. No.: US 2025/0054130 A1
(43) Pub. Date: Feb. 13, 2025

(54) Wafer Map Recognition Method Using Artificial Intelligence AND Computer Device

(71) Applicant: MEDIATEK INC., Hsin-Chu (TW)

(72) Inventors: En Jen, Hsinchu City (TW); Shao-Yun Liu, Hsinchu City (TW); Yi-Ju Ting, Hsinchu City (TW); Chin-Tang Lai, Hsinchu City (TW); Chia-Shun Yeh, Hsinchu City (TW); Ching-Yu Lin, Hsinchu City (TW); Ching-Han Jan, Hsinchu City (TW); Po-Hsuan Huang, Hsinchu City (TW)

(73) Assignee: MEDIATEK INC., Hsin-Chu (TW)

(21) Appl. No.: 18/798,858

(22) Filed: Aug. 9, 2024

Related U.S. Application Data
(60) Provisional application No. 63/518,963, filed on Aug. 11, 2023.

(51) Int. Cl. G06T 7/00; G06V 10/762

(52) U.S. Cl. CPC G06T 7/0006; G06V 10/762; G06T 2207/20081; G06T 2207/30148

(57) ABSTRACT

A wafer map recognition method using artificial intelligence includes obtaining wafer maps of a plurality of wafers; performing an unsupervised algorithm on the wafer map of each wafer in the plurality of wafers to generate a feature data set for the corresponding wafer map; and performing a clustering algorithm according to a plurality of feature data sets for the plurality of wafer maps to find a wafer map with a potential defect.

### CROSS REFERENCE TO RELATED APPLICATIONS

This application claims the benefit of U.S. Provisional Application No. 63/518,963, filed on Aug. 11, 2023. The content of the application is incorporated herein by reference.

### BACKGROUND

In the semiconductor manufacturing process, early identification of defects on wafers is critical to identify the root cause of issues and improve fabrication yields. If defects are not identified at an early stage, it may result in return merchandise authorization (RMA) and may result in significant monetary costs.

However, the fab may scan millions of wafers every day, the amount of wafer maps is huge and it is impossible to manually check the wafer maps one by one. The prior art uses rule based system to identify the defects of the wafers. However, since there are many types of abnormalities, it's difficult to consider all types of abnormalities. The rule based system can only consider common types of abnormalities and cannot detect all types of abnormalities.

And since the number of normal wafers is much greater than the number of abnormal wafers, using the traditional method to find defective wafers requires a lot of manpower and resources.

### SUMMARY

According to an embodiment of the invention, a wafer map recognition method includes obtaining wafer maps of a plurality of wafers; performing an unsupervised algorithm on the wafer map of each wafer in the plurality of wafers to generate a feature data set for the corresponding wafer map; and performing a clustering algorithm according to a plurality of feature data sets for the plurality of wafer maps to find a wafer map with a potential defect.

According to an embodiment of the invention, a computer device includes a processor and a memory. The memory is used for storing instructions, wherein the instructions are performed by the processor to perform: obtaining wafer maps of a plurality of wafers; performing an unsupervised algorithm on the wafer map of each wafer in the plurality of wafers to generate a feature data set for the corresponding wafer map; and performing a clustering algorithm according to a plurality of feature data sets for the plurality of wafer maps to find a wafer map with a potential defect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a computer system for performing a wafer map recognition method according to the present invention.

FIG. 2 shows a flowchart of a wafer map recognition method according to an embodiment of the present invention.

FIG. 3 shows a diagram of two-dimensional projection of vectors.

FIG. 4 shows a diagram of three-dimensional projection of vectors.

FIG. 5 shows a flowchart of a method when a wafer map pattern corresponding to a potential defect of a wafer is found according to an embodiment of the present invention.

FIG. 6 shows a flowchart of Step S507 in FIG. 5 according to an embodiment of the present invention.

### DETAILED DESCRIPTION

Unsupervised learning in AI (Artificial Intelligence) is a method that uses machine learning algorithms to analyze unlabeled data so the machine learns from data without human supervision. Unlike supervised learning algorithms, unsupervised learning algorithms are given unlabeled data and are allowed to discover hidden patterns or data groupings without labeling the data or human intervention.

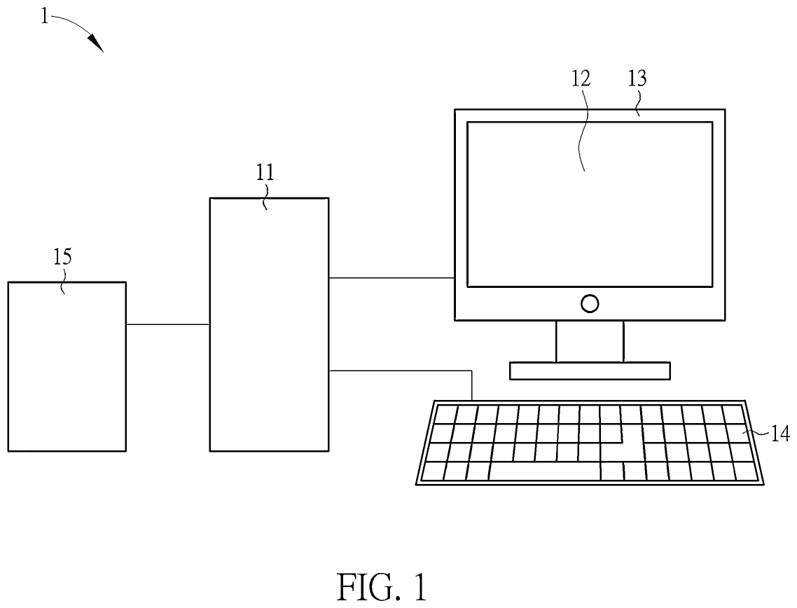

FIG. 1 shows a computer system 1 for performing the wafer map recognition method. The computer system 1 may include a central processing unit (CPU) 11, a graphical user interface (GUI) 12, a display device 13, an input device 14, and a memory 15. The display device 13, the input device 14, and the memory 15 are connected to the central processing unit (CPU) 11. Users may interact with the graphical user interface 12 on the display device 13 by using the input device 14. The input device 14 may be a mouse, a touch pad or a keyboard. The memory 15 may be a dynamic random access memory (DRAM), a static random-access memory (SRAM), or a read only memory (ROM). The CPU 11 may perform the wafer map recognition method.

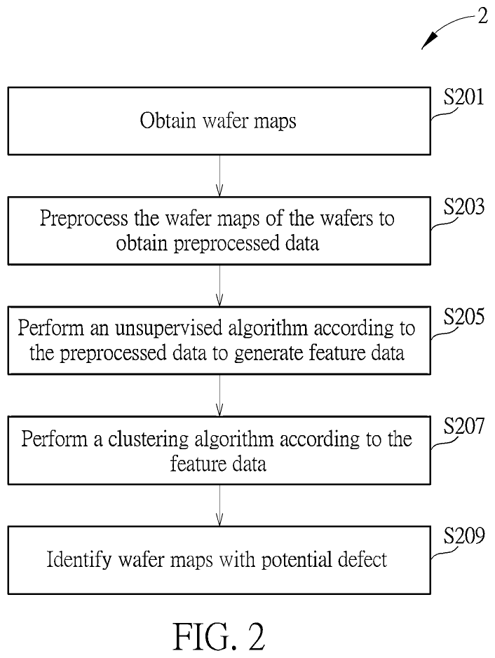

FIG. 2 shows a flowchart of a wafer map recognition method according to an embodiment of the present invention. The wafer map recognition method includes Steps S201 to S209. Any reasonable step change or adjustment is within the scope of the disclosure. Steps S201 to S209 are explained as follows:
Step S201: Obtain wafer maps of a plurality of wafers;
Step S203: perform an unsupervised algorithm on the wafer map of each wafer in the plurality of wafers to generate feature data set for the corresponding wafer map, wherein the feature data set may be a multi-dimensional vector;
Step S205: Perform a clustering algorithm according to feature data sets of the wafer maps;
Step S207: Identify potential defective wafer maps based on the results of the clustering algorithm.

In Step S201, the CPU 11 obtains wafer maps. The wafer maps are generated according to measurement data obtained by measuring the wafers. A wafer map is a map used to visualize properties of a semiconductor wafer. The wafer map may represent the performance of semiconductor devices on a substrate by showing the performance as a color-coded grid. In the present invention, the wafer map may represent the performance of all regions on the wafer or the performance of a part of regions on the wafer. That is, the wafer map recognition method may be performed according to wafer maps of complete wafers or part of the wafers. The wafer map may be an image that displays the electrical characteristics of each of the cells in the plan view of the wafer based on a raw data. For example, the wafer map may be an image to which the raw data is mapped. In some example embodiments, the cells may comprise good cells and bad cells. The good cell may represent a cell having good characteristics, and the bad cell may represent a cell having bad characteristics. For example, the good cells may include cells having electrical characteristics equal to or greater than a threshold value, and the bad cells may include cells having electrical characteristics less than the threshold value. The good cells and the bad cells may be represented with different fill shapes, brightness, saturation, and/or color, but example embodiments are not limited thereto.

In some embodiments, data preprocessing may be performed on measurement data obtained by measuring the wafers before obtaining the wafer maps. The method to preprocess data before obtaining the wafer maps may be normalization operations, smoothing, and/or missing value imputation to the measurement data obtained by measuring the wafers. Missing value imputation may be done by averaging the measurement values of dies near a missing value, and interpolate the average to the missing position.

In Step S203, the CPU 11 performs an unsupervised algorithm on the wafer maps of the plurality of wafers. The unsupervised algorithm may be BEiT, which may stand for bidirectional encoder representation from image transformers, or other vision transformer algorithm, but not limited thereto. BEIT is a self-supervised vision representation algorithm, and may include a pre-training task Masked Image Modeling (MIM). MIM is a technique for predicting the missing values in an image according to the surrounding values and may be used to predict discrete visual token values, which may achieve better accuracy in image classification. The unsupervised algorithm may include feed forward neural network, pooling and/or dimension reduction, but not limited thereto. A feed forward neural network is a type of artificial neural network. In a feed forward neural network, the information moves forward from the input nodes, through the hidden nodes, and to the output nodes. Pooling is to divide the data into small regions, and perform an aggregation operation. The aggregation operation may be taking the maximum value or taking the average value within each small region. The aggregation operation may reduce the size of the feature data, resulting in a compressed representation of the data. The dimension reduction is to project high dimensional data to a lower dimensional space. By performing the unsupervised algorithm for each wafer map, a multi-dimensional vector corresponding to the wafer map may be obtained. If the multi-dimensional vector has N dimensions, it means that the wafer map is represented by N features. The element in the multi-dimensional vector represents a probability that the wafer map has a certain feature. The values of N elements mean probabilities of N features of the wafer map.

In Step S205, the CPU 11 performs a clustering algorithm according to the multi-dimensional vectors obtained in Step S203. The clustering algorithm may be a DBSCAN (density-based spatial clustering of applications with noise) algorithm, but not limited thereto. The DBSCAN algorithm may be a density-based spatial clustering algorithm. The performance of the DBSCAN algorithm may depend on two main parameters: eps (neighborhood radius) and minPts (minimum number of points). Eps defines the neighborhood range of a point, while minPts specifies the minimum number of points required for an area to be considered a dense region. DBSCAN can identify and label noise points, which are isolated points that do not belong to any cluster. DBSCAN algorithm may deal with a large amount of parametric data without manual labeling.

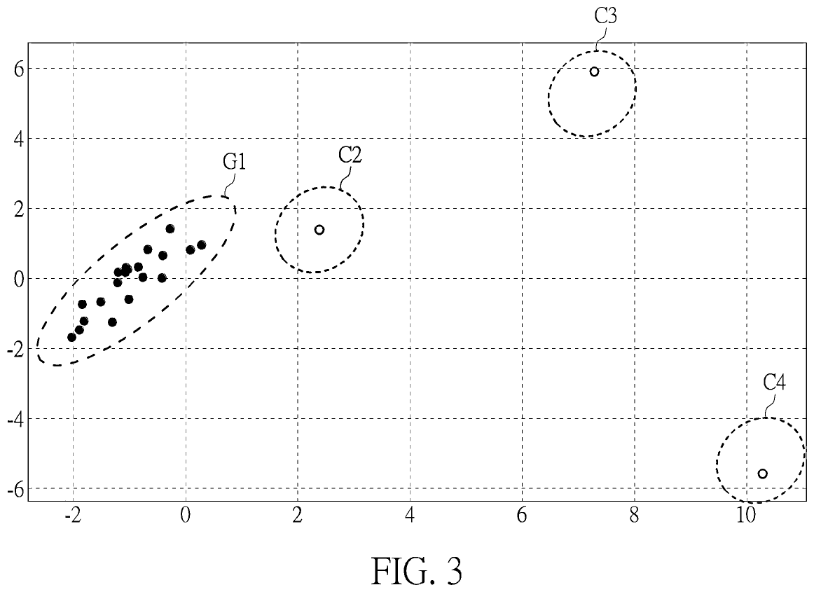

By using the clustering algorithm to perform cluster analysis on a plurality of multi-dimensional vectors corresponding to a plurality of wafer maps obtained in Step S203, the plurality of multi-dimensional vectors corresponding to the plurality of wafer maps may be projected to a plurality of point in a multi-dimensional space. The number of dimensions of the vector may be the same as the number of dimensions of the space. Each multi-dimensional vector may be projected to one point in the multi-dimensional space. For example, the vector corresponding to the wafer map comprises 768 dimensions. One 768-dimensional vector is projected to one point in a 768-dimensional space. The points corresponding to the normal wafer maps in the multi-dimensional space may be clustered together. For ease of viewing, FIG. 3 shows a two-dimensional diagram to present the plurality of points corresponding to the plurality of maps in the multi-dimensional space.

In Step S207, the CPU 11 identifies wafer maps with potential defect according to the projection of vectors from Step S205. After performing the clustering algorithm in Step S205, the points corresponding to the normal wafer maps may be clustered together, while the points corresponding to the wafer maps with potential defect may be segregated. That is, a wafer map pattern corresponding to a potential defect of a wafer is the outlier generated by performing the clustering algorithm according to the feature data set of the wafer map. Please refer to FIG. 3 as an example, if a point is in Group G1, the wafer map corresponding to the point is not defective. That is, the wafer corresponding to the wafer map is not defective. The points corresponding to the normal wafer maps are clustered together in Group G1, while the points corresponding to the wafer maps with potential defect are distinctly segregated, as shown by circles C2, C3, and C4, thereby being identifiable as outliers. By performing the wafer map recognition method, the wafer maps with potential defect may be found without checking or labeling one by one. In FIG. 3, the points corresponding to the normal wafer maps are clustered together in only one group, but it's not limited thereto. In other embodiment, the points corresponding to the normal wafer maps may be clustered together in multiple groups.

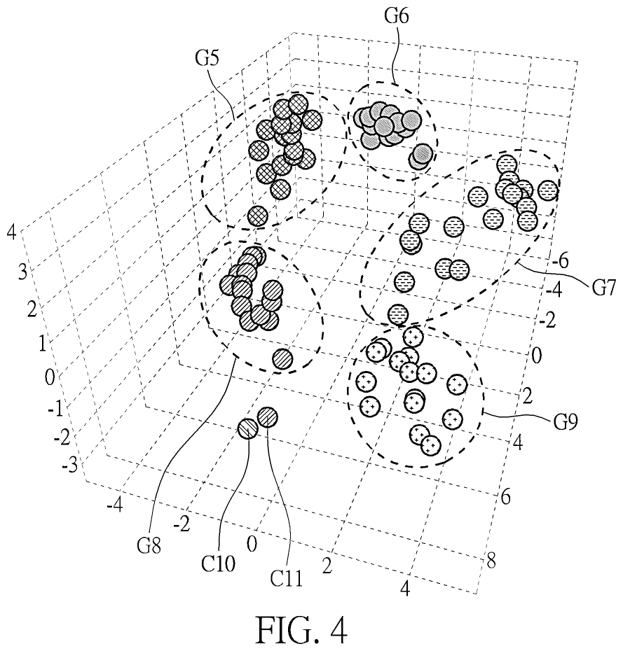

FIG. 4 shows a three-dimensional diagram to present a plurality of points corresponding to a plurality of wafer maps in the multi-dimensional space. As shown in FIG. 4, after performing the clustering algorithm in Step S205, the CPU 11 had clustered the wafer maps into five distinct groups G5-G9 and retain a few separate points. The points corresponding to the normal wafer maps are clustered together in Groups G5-G9, while the points corresponding to the wafer maps with potential defect are distinctly segregated, as indicated by a C10 and C11, thereby being identifiable as outliers. As shown in FIG. 4, the points C10 and C11 deviate from the Groups G5-G9, which suggests that there may be a potential issue with the points C10 and C11. In this embodiment of the present application, one group may include at least 3 points.

After performing Step S207, the wafer map patterns corresponding to potential defects of wafers may be found and may be displayed on a graphical user interface (GUI) 12 on the display device 13 in FIG. 1. Users may interact with the graphical user interface 12 and determine whether the pattern on the wafer map is a defect of the wafer by using the input device 14.

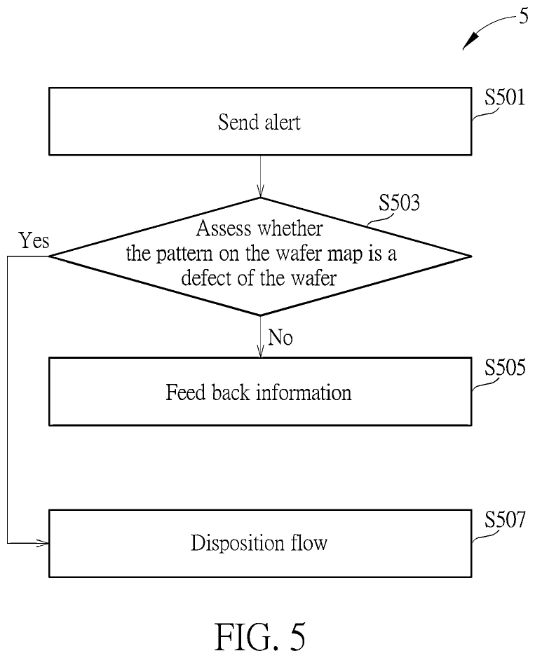

FIG. 5 shows a flowchart of a method 5 when a wafer map pattern corresponding to a potential defect of a wafer is found according to an embodiment of the present invention. The method 5 includes Steps S501 to S507. Any reasonable step change or adjustment is within the scope of the disclosure. Steps S501 to S507 are explained as follows:
Step S501: Send alert;
Step S503: Assess whether the wafer map with a potential defect actually has a defect based on the pattern of the wafer map, if not, go to Step S505; if so, go to Step S507;
Step S505: Feed back information;
Step S507: Disposition flow.

In Step S501, when a wafer map pattern corresponding to a potential defect of a wafer is found after performing the wafer map recognition method, an alert may be sent to a user. The alert may be sent via e-mail or displayed on the graphical user interface (GUI) 12 on the display device 13, but not limited thereto.

After sending the alert to the user in Step S501, in Step S503, assess whether the wafer map with a potential defect actually has a defect based on the pattern of the wafer map by testing or human evaluation. Specifically, in this step, assess whether the pattern on the wafer map correspond to a defect of a wafer. If the pattern on the wafer map is assessed not to correspond to a defect of a wafer, go to Step S505. If the pattern on the wafer map is assessed to correspond to a defect of a wafer, go to Step S507.

In Step S505, the information is fed back according to the pattern on the wafer map to a product monitoring module, so that when a map with the same pattern is encountered again, it will be regarded as a normal wafer map. No need to execute the unsupervised algorithm on it. In some embodiment, the information of the pattern on the wafer map that is assessed not to correspond to a defect of a wafer may be stored as a blacklist in the memory 15, to avoid misinterpretation in the future.

In one embodiment, multiple items can be tested on a wafer, and multiple wafer maps can be generated accordingly. After performing clustering analysis of the vectors corresponding to the wafer maps of the same test item of multiple wafers, if the outlier is not a real defect after the assessment, the item may not be tested in the future, and wafer maps for the item do not need to be generated.

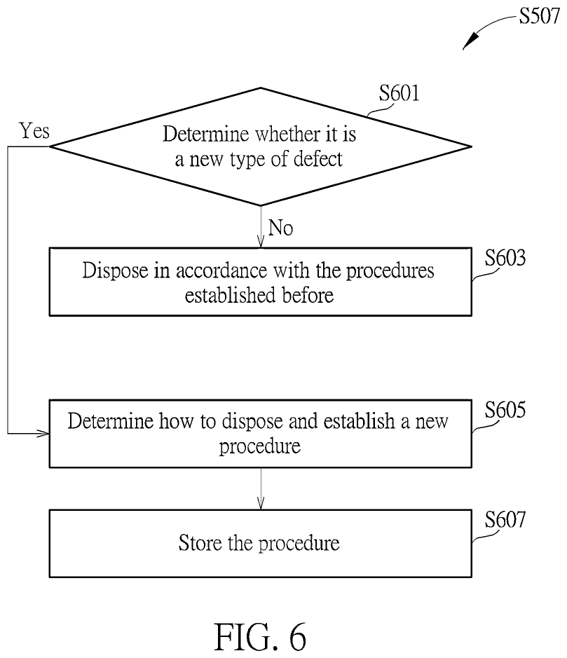

In Step S507, if the pattern on the wafer map is assessed to correspond to a defect of a wafer, perform a disposition flow. The detail of the disposition flow may refer to FIG. 6. FIG. 6 shows a flowchart of Step S507 in FIG. 5 according to an embodiment of the present invention. Step S507 includes Steps S601 to S607. Any reasonable step change or adjustment is within the scope of the disclosure. Steps S601 to S607 are explained as follows:
Step S601: Determine whether it is a new type of defect; if so, go to Step S605; else, go to Step S603,
Step S603: Dispose in accordance with the procedures established before;
Step S605: Determine how to dispose, and develop a procedure;
Step S607: Store the procedure.

In Step S601, the pattern on the wafer map is determined to correspond to a defect of a wafer, and the user may determine whether the defect of the wafer is a new type of defect that has not been dealt with before. If the defect of the wafer is not a new type of defect, go to Step S603. If the defect of the wafer is a new type of defect, go to Step S605.

If the defect of the wafer is not a new type of defect, indicating the type of the defect has been dealt with before. Therefore, in Step S603, the defect may be disposed in accordance with the procedures established before.

If the defect of the wafer is a new type of defect, indicating the type of the defect has not been dealt with before. Therefore, in Step S605, the user may determine how to dispose the defect of the wafer, and establish a new procedure. Then in Step S607, after the new procedure is developed, store the new procedure and update the disposition flow, so when the same type of defect occurs in the future, the defect may be disposed in accordance with the new procedure. The new procedure may be stored in the memory 15.

Since the wafer maps with potential defect may be found without human evaluation by performing the wafer map recognition method, and if the pattern on the wafer map is determined to correspond to a defect of a wafer that is not a new type of defect, the defect may be disposed in accordance with the procedures established before, which would save manpower and time.

In the present invention, the wafer map recognition method may perform the unsupervised algorithm on wafer maps to obtain multi-dimensional vectors, and then the clustering algorithm may be performed according to the vectors to project the vectors to a plurality of points respectively in a multi-dimensional space. Then, the wafer maps with potential defect may be preliminarily identified according to the projection of vectors. After the wafer maps with potential defect are preliminarily identified, whether the potential defect of the wafer corresponding to the pattern on the wafer map is a defect of the wafer may be assessed by testing or human evaluation. And if the potential defect of the wafer corresponding to the pattern on the wafer map is determined as a defect, the disposition flow may be performed. Through the wafer map recognition method, the wafer maps with potential defect may be preliminarily found without checking or labeling one by one and there is no need to list the types of abnormalities to find potential defects. Therefore, the wafer map recognition method would save a lot of manpower and time, and would identify wafers with potential defects in an early stage, thus reduce the occurrence of return merchandise authorization (RMA) situations and avoid large monetary losses.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wafer map recognition method, comprising:
obtaining wafer maps of a plurality of wafers;
performing an unsupervised algorithm on the wafer map of each wafer in the plurality of wafers to generate a feature data set for the corresponding wafer map; and
performing a clustering algorithm according to a plurality of feature data sets for the plurality of wafer maps to find a wafer map with a potential defect.

2. The method of claim 1, further comprising assessing whether the wafer map with a potential defect actually has a defect based on the pattern of the wafer map.

3. The method of claim 2, further comprising:
if the wafer map with a potential defect has not a defect based on the pattern of the wafer map, feeding back information according to the pattern on the wafer map to a product monitoring module; and
when receiving a wafer map with the same pattern again, do not perform the unsupervised algorithm on the wafer map with the same pattern.

4. The method of claim 2, further comprising:
if the wafer map with a potential defect actually has a defect based on the pattern of the wafer map, performing a disposition flow according to the pattern on the wafer map.

5. The method of claim 4, wherein the feature data set is a multi-dimensional vector, and the element in the multi-dimensional vector is used for indicating a probability that the wafer map has a certain feature.

6. The method of claim 1, wherein the wafer map contains at least part of an image of the wafer.

7. The method of claim 5, wherein performing a clustering algorithm according to a plurality of feature data sets for the plurality of wafer maps comprises projecting the plurality of multi-dimensional vectors for the plurality of wafers to a plurality of points in a multi-dimensional space, wherein a multi-dimensional vector of each wafer is projected to one point in the multi-dimensional space.

8. The method of claim 1, wherein the wafer map with the potential defect is an outlier generated by performing the clustering algorithm.

9. The method of claim 1, wherein the unsupervised algorithm contains vision transformation, pooling and/or dimension reduction.

10. The method of claim 1, wherein the clustering algorithm is a DBSCAN (density-based spatial clustering of applications with noise) algorithm.

11. The method of claim 1, wherein the wafer maps of a plurality of wafers are generated according to measurement data obtained by measuring the plurality of wafers.

12. The method of claim 11, further comprising:
performing normalization operations, smoothing, and/or missing value imputation to the measurement data before generating the plurality of wafer maps.

13. A computer device, comprising:
a processor; and
a memory storing instructions, wherein the instructions are performed by the processor to perform:
obtaining wafer maps of a plurality of wafers;
performing an unsupervised algorithm on the wafer map of each wafer in the plurality of wafers to generate a feature data set for the corresponding wafer map; and
performing a clustering algorithm according to a plurality of feature data sets for the plurality of wafer maps to find a wafer map with a potential defect.

14. The device of claim 13, wherein the feature data set is a multi-dimensional vector, and the element in the multi-dimensional vector is used for indicating a probability that the wafer map has a certain feature.

15. The device of claim 14, wherein performing a clustering algorithm according to a plurality of feature data sets for the plurality of wafer maps comprises projecting the plurality of multi-dimensional vectors for the plurality of wafers to a plurality of points in a multi-dimensional space, wherein a multi-dimensional vector of each wafer is projected to one point in the multi-dimensional space.

16. The device of claim 13, wherein the wafer map with the potential defect is an outlier generated by performing the clustering algorithm.
